(19) United States
(12) Patent Application Publication
(10) Pub. No.: US 2024/0035674 A1
(43) Pub. Date: Feb. 1, 2024

(54) DEVICE FOR GENERATING HEAT TO A USER

(71) Applicant: Paul Joseph Schafer, Portland, ME (US)

(72) Inventor: Paul Joseph Schafer, Portland, ME (US)

(21) Appl. No.: 18/356,629

(22) Filed: Jul. 21, 2023

Related U.S. Application Data
(60) Provisional application No. 63/392,705, filed on Jul. 27, 2022.

(51) Int. Cl. F24D 5/08; F24B 7/02

(52) U.S. Cl. CPC F24D 5/08; F24B 7/02; A47C 7/748

(57) ABSTRACT

A device for generating heat to a user is provided. The device may include an air receptacle having at least one air inlet and one air outlet, a chimney having a first end coupled to the at least one outlet of the air receptacle, and a second open end, and a heat exchanger positioned about a periphery of the chimney and having at least one air inlet and at least one air outlet. The device may also include a structure having at least one surface configured to provide heat to a user, where the structure has at least one air inlet coupled to the at least one air outlet of the heat exchanger, and at least one air outlet coupled to the at least one air inlet of the air receptacle. The device may be configured such that when a combustible material is placed in the device, the device heats air within the air receptacle and the heated air travels through the chimney, heating the air within the heat exchanger, circulating the air from the heat exchanger into the structure, and back into the air receptacle. The device may include a grate positioned adjacent the air receptacle, where the grate is configured to hold a combustible material.

### RELATED APPLICATIONS

The present application claims the benefit under 35 U.S.C. § 119(e) to U.S. Provisional Application No. 63/392,705 filed on Jul. 27, 2022, the contents of which is incorporated by reference herein in its entirety.

### FIELD OF THE INVENTION

This disclosure relates to a device used for generating heat to a user.

### BACKGROUND

A variety of types of devices exist to generate heat to a user, typically designed for outdoor use. For example, chemical hand and toe warmers can be placed in a user's pockets, mittens, shoes or socks to keep a user's body warm. These are typically disposable and only last between four and six hours. Furthermore, a wide variety of electrical battery-powered heated clothing, such as vests, jackets, socks, and mittens exist to keep a user's body warm. These may rely on either disposable or rechargeable batteries and also typically have a limited time period within which they work before the battery is depleted. There are a variety of heat lamps and outdoor space heaters (often which rely on electricity) to generate and circulate heated air through an outdoor space. Finally, there are a wide variety of outdoor fireplaces, fire pits which are configured to generate heat to a user.

### SUMMARY

According to one aspect of the present disclosure, a device for generating heat to a user is provided. The device includes an air receptacle having at least one air inlet and one air outlet, a chimney having a first end coupled to the at least one outlet of the air receptacle and a second open end, and a heat exchanger positioned about a periphery of the chimney, the heat exchanger having at least one air inlet and at least one air outlet. The device further includes a structure having at least one surface configured to provide heat to a user, where the structure has at least one air inlet coupled to the at least one air outlet of the heat exchanger, and where the structure has at least one air outlet coupled to the at least one air inlet of the air receptacle. The device is configured such that when a combustible material is placed in the device, the device heats air within the air receptacle and the heated air travels through the chimney, heating the air within the heat exchanger, circulating the air from the heat exchanger into the structure, and back into the air receptacle.

According to another aspect, a device for generating heat to a user is provided. The device includes an air receptacle having at least one air inlet and one air outlet, and a chimney having a first end coupled to the at least one outlet of the air receptacle and a second open end. The device also includes a grate positioned adjacent the air receptacle, where the grate is configured to hold a combustible material, and a heat exchanger positioned about a periphery of the chimney, the heat exchanger having at least one air inlet and at least one air outlet. The device is configured such that when a combustible material is placed on the grate, the device heats air within the air receptacle and the heated air travels through the chimney, heating air within the heat exchanger.

### BRIEF DESCRIPTION OF THE DRAWINGS

FIG. 1 is a perspective view of a device for generating heat to a user according to one embodiment;

FIG. 2 is a cross-sectional cut perspective of the device shown in FIG. 1;

FIG. 3 is a cross-sectional cut side view of the device shown in FIG. 1;

FIG. 4 is a perspective view of an air receptacle according to one embodiment;

FIG. 5 is a perspective view of a grate according to one embodiment;

FIG. 6 is a perspective view of a chimney according to one embodiment;

FIG. 7 is a perspective view of a heat exchanger according to one embodiment;

FIG. 8 is a perspective view of a structure having at least one surface configured to provide heat to a user according to one embodiment;

FIG. 9 is an exploded assembly view of one embodiment of a device for generating heat to a user;

FIG. 10 is a top view of another embodiment of a device for generating heat to a user;

FIG. 11 is a side view of another embodiment of a device for generating heat to a user;

FIG. 12 is a side view of yet another embodiment of a device for generating heat to a user; and

FIG. 13 is top view of another embodiment of a device for generating heat to a user.

### DETAILED DESCRIPTION

The present disclosure is directed to a device for generating heat to a user. The Applicant recognized that there is a need for a new device configured to keep people and/or pets warm while enjoying the outdoors. The Applicant recognized that many people enjoy sitting by a fire pit/stove, and although a traditional outdoor fire stove is configured to generate heat, much of the heated air is directed upwardly and is lost into the surrounding environment.

In one embodiment, the device is configured to be a heating focal point of an outdoor social or family gathering, although in certain embodiments, the device may also be configured for indoor use. Portions of the device may be configured similar to a fire pit, such that one or more users can gather around the fire created in the device. As set forth in more detail below, aspects of the present disclosure are directed to a device which is configured to convert some of the heat generated from a fire that would be otherwise lost into the surrounding environment and use it to generate additional heat to a user.

As set forth in more detail below, aspects of the present disclosure are directed to a device which includes a heat exchanger positioned about a periphery of a chimney, so that as heated air travels up through the chimney, the heat exchanger positioned about the periphery of the chimney is capable of capturing some of the heat that would otherwise be lost through the chimney and into the surrounding environment.

As discussed in more detail below, the device may include a structure having at least one surface configured to provide heat to a user. In one particular embodiment, the structure may be defined as a seating area box and/or a seating structure. The structure itself may be formed into a piece of furniture, such as, but not limited to a bench or a chair, and the structure may be coupled to the heat exchanger so that heated air from the heat exchanger can flow into the structure to heat the user. In other words, the device may use heat and convection of combustion to circulate hot air into the structure to provide heat to a user. In one embodiment, the structure may be spaced a small distance away from the chimney and heat exchanger, so that a user may sit on the structure and be warmed by both the fire in the chimney and the user may also be warmed by the heated surface of the structure.

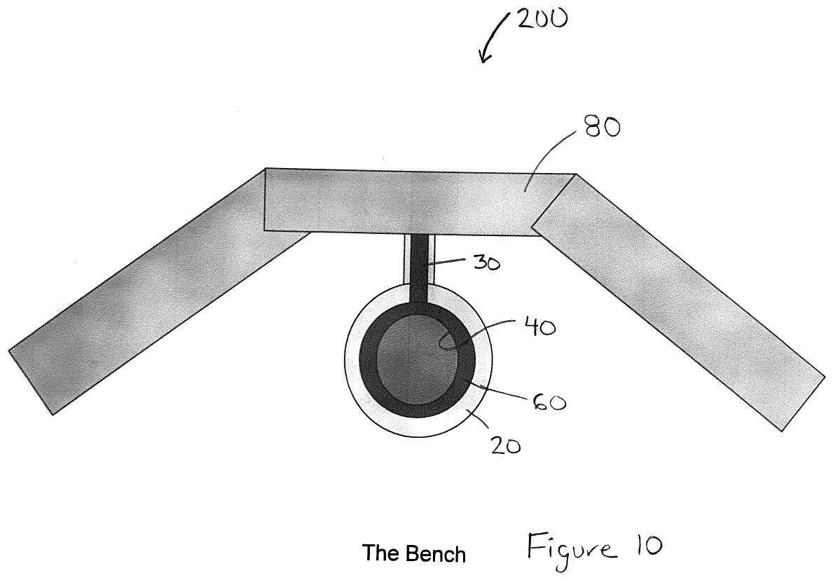

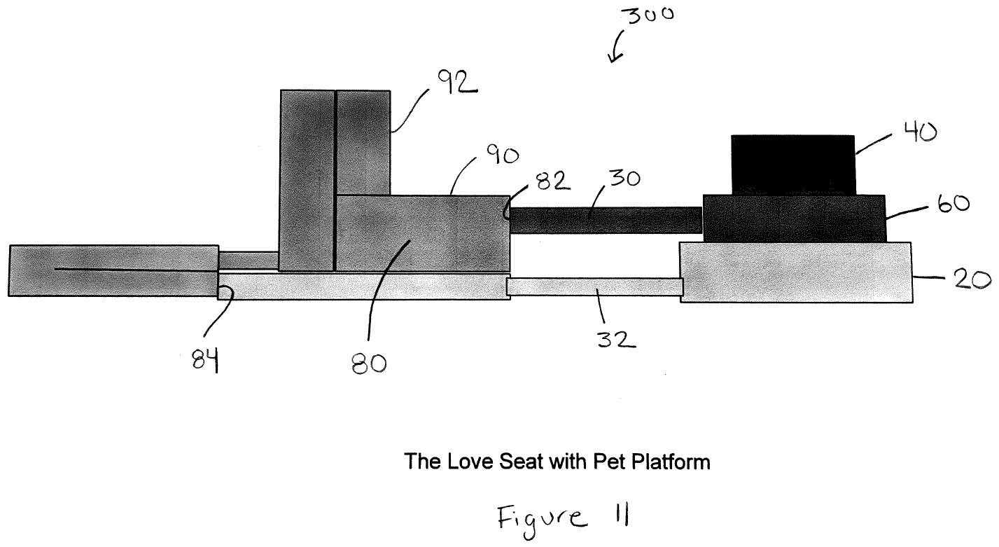

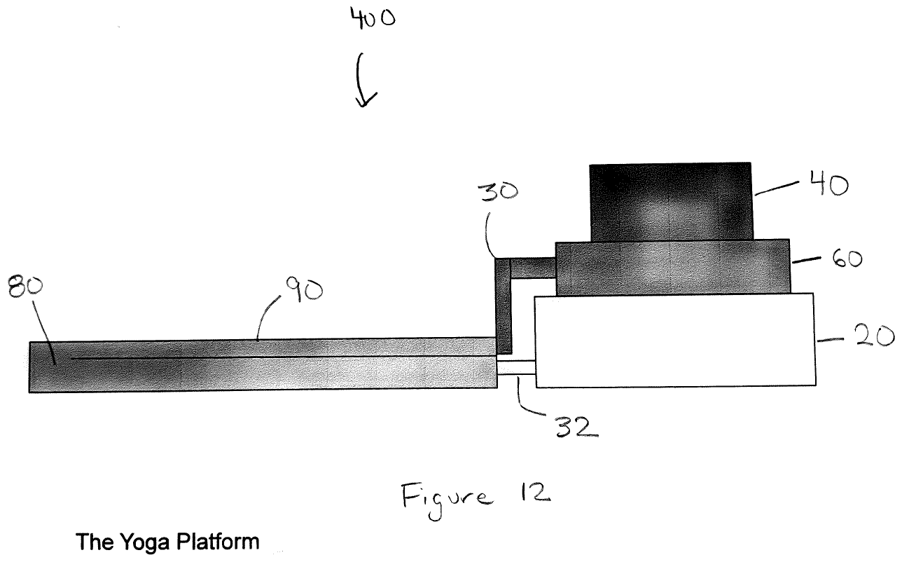

In one embodiment, the fire in the chimney may create a vacuum pull within the device which may draw air into the heat exchanger that extends about the periphery of the chimney. As set forth in more detail below, the heated air may then be drawn into a larger structure where the air may slow down and heat the inside of the structure. As set forth below, the structure may have any shape, such as an Adirondack chair, a yoga platform (see FIG. 12), a pet bed (see FIG. 11), a loveseat (also see FIG. 11), a bench, and/or a curved or circle bench/couch that extends around the chimney (see FIGS. 10 and 11). The air may then be drawn out the bottom of the structure and back to the fire to fuel the fire from below.

As set forth in more detail below, in one embodiment, the system of airflow may be open at both ends, one end where a fire burns directly above it (i.e., at the top of the chimney), and the other end can be open to ambient air to provide air into the heat exchanger. The remainder of the system of airflow may be airtight. The diameter of the airflow path that the air takes through the device may be narrowed to increase the velocity near the heat source and the diameter of the airflow path may be widened to decrease the velocity in the structure to maximize efficiency and heating to the structure and also to allow room in the device for the heated air to expand. In one embodiment, the device is configured to create a vacuum inside of the device which draws heated air from the heat exchanger into the structure to heat a user, and back into the air receptacle.

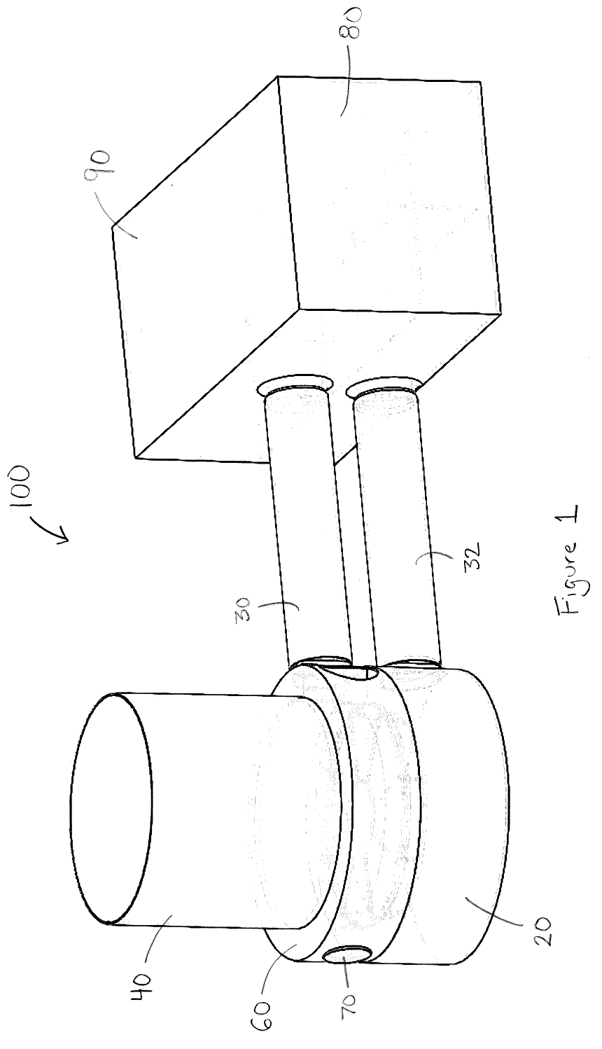

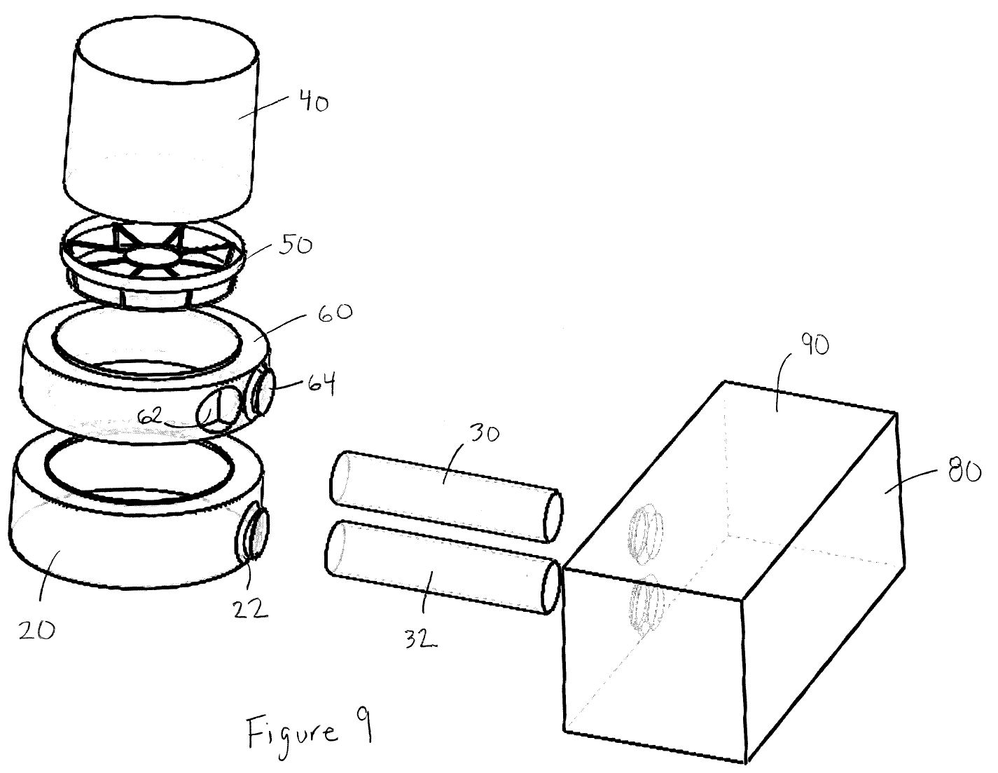

Turning now to FIGS. 1-9, one embodiment of the device 100 for generating heat to a user will now be more fully described. FIG. 1 is a perspective view of a device 100 which includes an air receptacle 20, a chimney 40, a heat exchanger 60 positioned about a periphery of the chimney 60, and a structure 80 having at least one surface 90 configured to provide heat to a user. In one particular embodiment, conduit 30 couples the heat exchanger to the structure 80, and conduit 32 couples the structure 80 back to the air receptacle 20 to complete the airflow path to and from the structure 80.

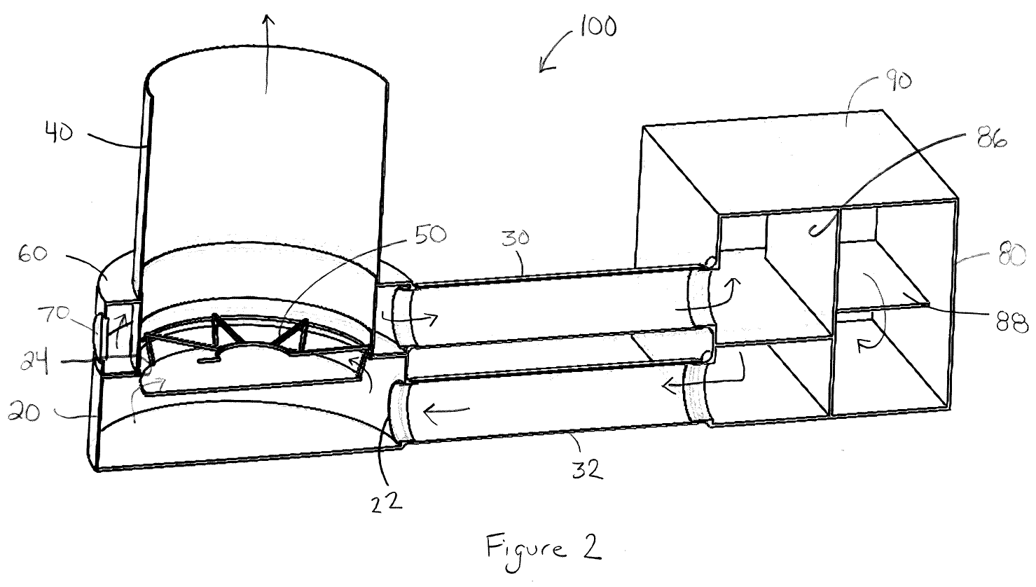

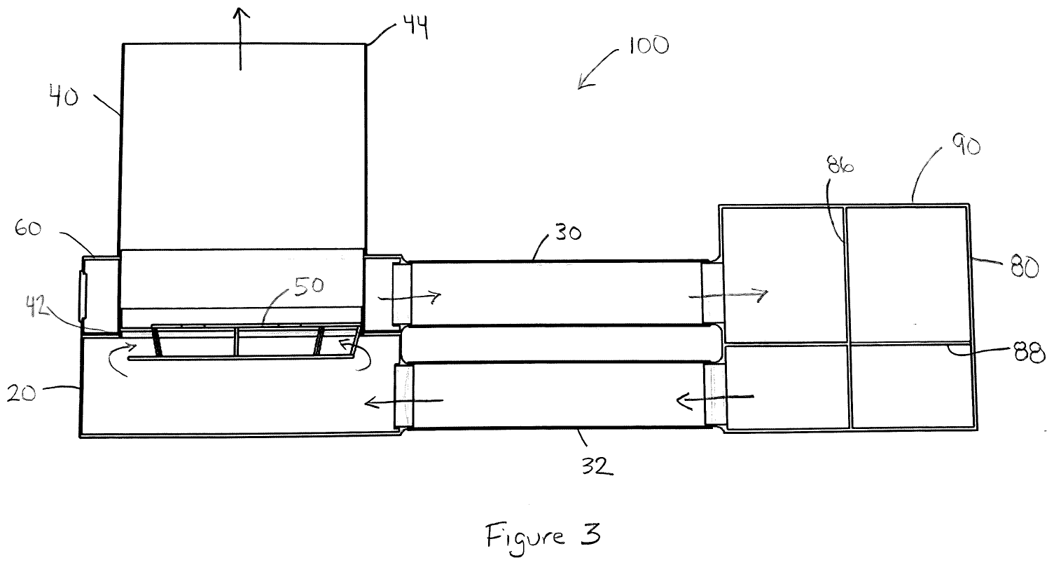

FIG. 2 is a cross-sectional cut perspective of the device 100 and FIG. 3 is a cross-sectional cut side view of the device 100, both of which illustrate the internal flow of air through the device 100 when a combustible material is placed in the device 100. As an overview, when a combustible material is placed in the device 100, the device 100 may heat air within the air receptacle 20, and the heated air may travel up through the chimney 40, which heats the air within the heat exchanger 60. As shown in FIGS. 2-3 by the representative air flow arrows, the heated air may exit the heat exchanger 60 and circulate into the structure 80 (via upper conduit 30) causing the surface 90 to heat up. As shown by the representative arrows, after the heated air circulates through the structure 80, the air may travel back into the air receptable 20 (via lower conduit 32). As shown by the arrows, in one embodiment, there is substantially a recirculating air flow path between the heat exchanger 60, the structure 80, the air receptacle 20, and the chimney 40.

As set forth in more detail below, in one embodiment, the device 100 may include a grate 50 which may be positioned adjacent the air receptacle 20, and the grate 50 is configured to hold a combustible material. One of ordinary skill in the art will appreciate that the combustible material may include various materials, including but not limited to wood logs, pellets, fossil fuels, and/or oils.

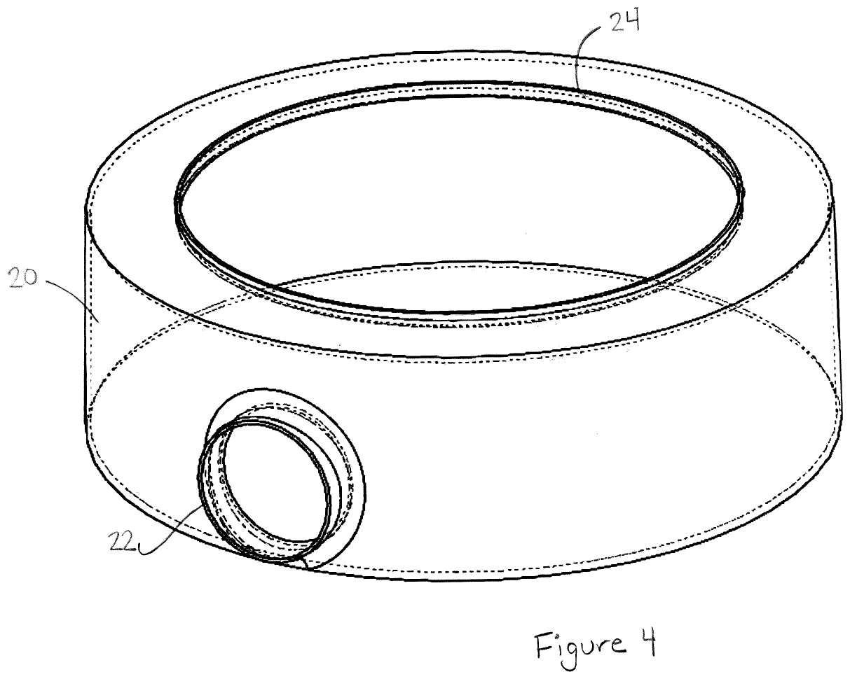

FIG. 4 illustrates one embodiment of the air receptable 20 in greater detail. As shown, the air receptacle 20 includes at least one air inlet 22 and at least one air outlet 24. As shown in FIGS. 1-3, the air inlet 22 may be coupled to the structure 80 via conduit 32. Furthermore, the chimney 40 may be coupled to the at least one air outlet 24 of the air receptacle 20. In one particular illustrative embodiment, the air receptacle 20 has a substantially cylindrical shape with a substantially a circular shaped air inlet 22 and air outlet 24. It should be appreciated that other shapes, such as but not limited to cubic, cuboid, prism, spherical, conical, and/or other irregular shaped air receptacles are also contemplated. Furthermore, although in this particular embodiment, only one air inlet 22 and one air outlet 24 are illustrated, it is contemplated that two, three, four or more air inlets and/or air outlets are also contemplated as the disclosure is not so limited.

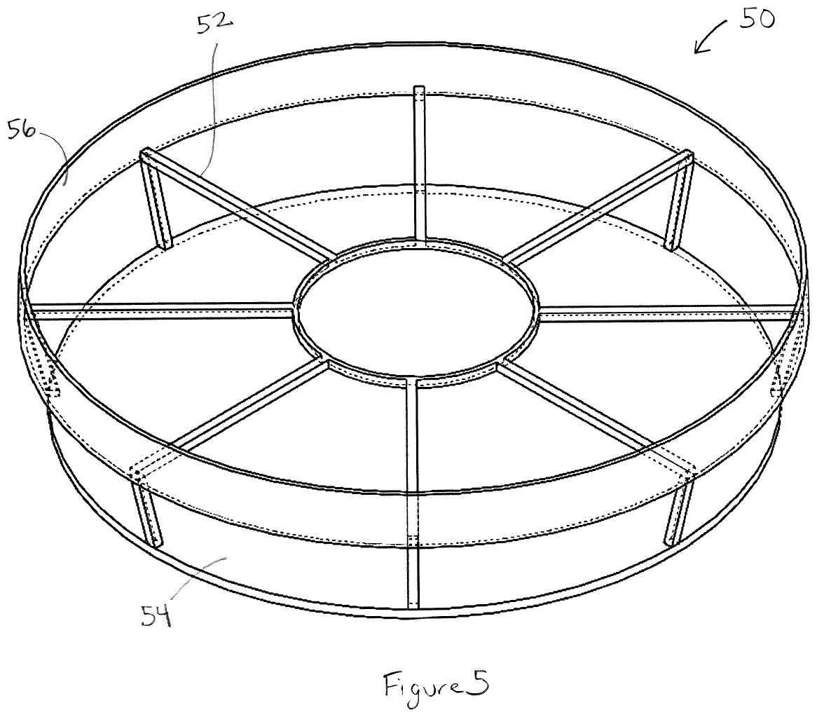

FIG. 5 illustrated one embodiment of a grate 50. As mentioned above, the grate 50 is configured to hold a combustible material. In one embodiment, the grate 50 includes a plurality of ribs 52 coupled to a bottom plate 54 and an upper annular cap 56. As shown, the ribs 52 may include substantially L-shaped legs which space the annular cap 56 from the bottom plate 54. As shown in FIGS. 2-3, the grate 50 may be positioned adjacent the air receptacle 20 such that the space created between the annular cap 56 and the bottom plate 54 forms a circular air flow path enabling heated air from the air receptable 20 to flow upwardly through the chimney 40. In another embodiment, the grate 50 may be configured differently, and may for example have a plate-like configuration. There may be one or more holes therethrough to promote airflow.

In one embodiment, the grate 50 may perform multiple functions. First, the grate 50 may act as a backstop and heat shield that forces more of the fire's energy upward and through the chimney 40. Second, when there is a gap between the grate 50 and the chimney wall 46, cooler air from the air receptacle 20 below may be guided to the outside of the fire which may reduce turbulence. In one embodiment, the grate 50 may include a plate 54 which may be concave to keep coal and/or ashes that fall from the fire away from the air inlets and air outlets through which the heated air circulates.

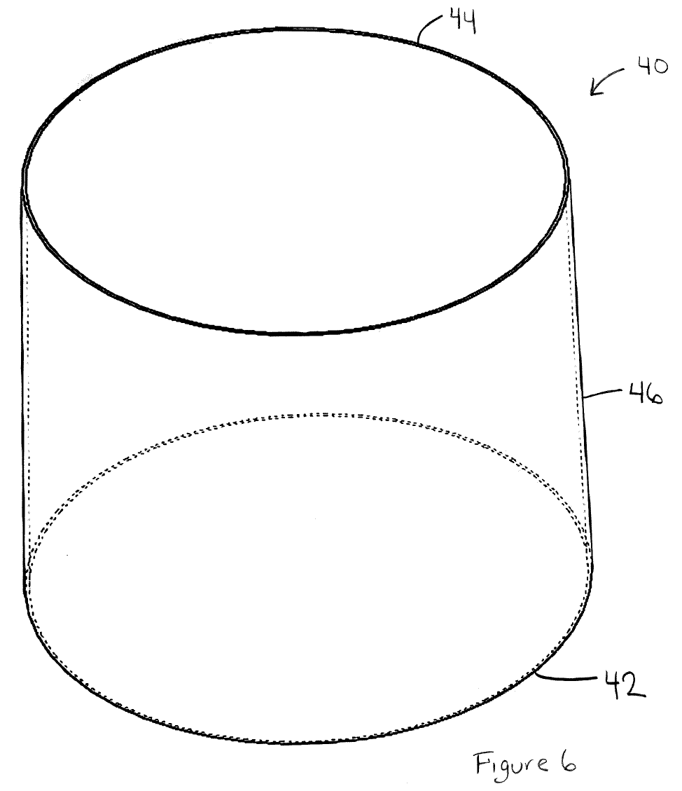

FIG. 6 is a perspective view of a chimney 40 according to one embodiment. As shown, the chimney 40 includes a first end 42 and a second open end 44. In this illustrative embodiment, the chimney 40 has a substantially cylindrical shape with substantially circular shaped first end 42 and open end 44. It should be appreciated that other shapes, such as but not limited to cubic, cuboid, prism, spherical, conical, and/or other irregular shaped chimneys are also contemplated.

One of ordinary skill in the art will appreciate that when a combustible material is burned within the device 100, the device 100 heats air within the air receptacle 20 and the heated air travels up though the chimney 40 from the first end 42 and out through the second open end 44. Also, as the heated air travels through the chimney 40, the wall 46 of the chimney may also heat up. As discussed above, a heat exchanger 60 is positioned about a periphery of the chimney 40, and the heat exchanger is configured to transfer some of the heat from the chimney 40 into the heat exchanger 60. In other words, as the wall 46 of the chimney 40 heat up, the air within the heat exchanger 60 may also heat up.

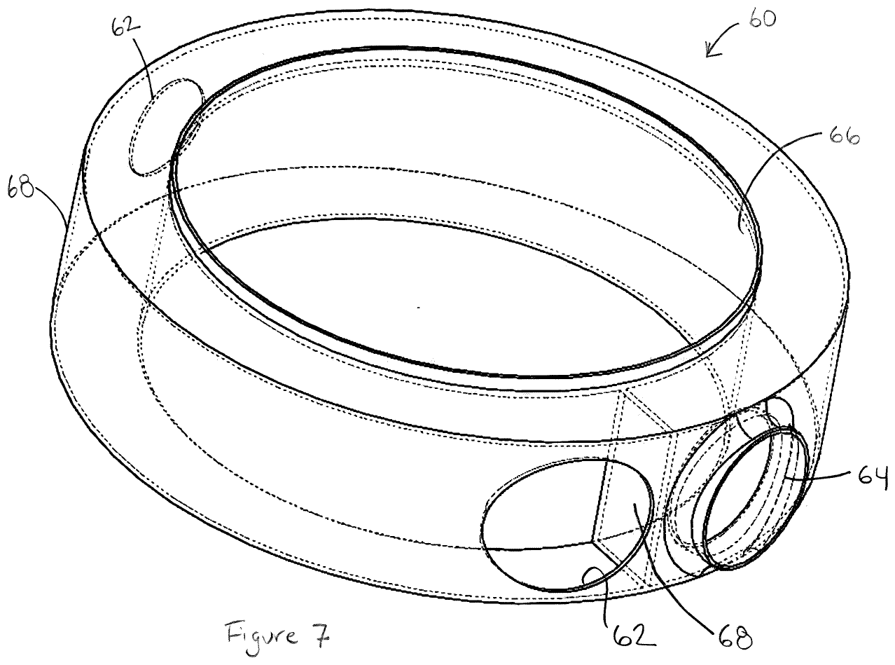

Turning now to FIG. 7, one embodiment of the heat exchanger 60 will now be more fully described. As shown, the heat exchanger 60 is configured to be positioned about a periphery of the chimney 40. In this particular embodiment, the chimney 40 has a substantially cylindrical shape and the heat exchanger extends around the entire 360° perimeter of the chimney 40. It should be appreciated that in another embodiment, the heat exchanger 60 may extend about a periphery of the chimney 40 without extending around the entire circumference. For example, in one embodiment, it is contemplated that the heat exchanger 60 extends around at least a majority of the perimeter of the chimney 40 (i.e., at least about 180° when the chimney has a circular cross section). In another embodiment, it is contemplated that the heat exchanger 60 extends around at least three quarters of the perimeter of the chimney (i.e., at least about 270° when the chimney has a circular cross section). As set forth in more detail below, in another embodiment, the heat exchanger and/or the chimney may be shaped differently, and may for example have non-circular cross sections, as the present disclosure is not limited in this respect.

As shown in FIG. 7, in one embodiment, the heat exchanger has an annular shape (i.e., ring shape) where the inside wall 66 of the heat exchanger 60 substantially matches the size and shape of the cylindrical wall 46 of the chimney 40. As shown in FIG. 7, the heat exchanger 60 has at least one air inlet 62 and at least one air outlet 64. In one embodiment, the air inlet 62 is open to the surrounding environment (i.e., ambient air), and the air outlet 64 is coupled to conduit 30 to circulate the heated air from the heat exchanger 60 into the structure 80. As shown in FIG. 7, in one embodiment, the heat exchanger 60 may include a plurality of air inlets 62, and as shown in FIG. 1, at least one of the air inlets 62 may include a removable cap 70 to selectively modify the air flow through the heat exchanger 60. It should be recognized that in another embodiment, the heat exchanger may be shaped differently, and may for example have a rectangular shape, as the present disclosure is not so limited.

As shown in FIG. 7, in one embodiment, the heat exchanger 60 includes at least one inner partition 68 configured to guide airflow inside of the heat exchanger 60. For example, in one illustrative embodiment, an inner partition 68 (i.e., inner wall) is positioned vertically between an air inlet 62 and an air outlet 64 to guide the air to flow around the periphery of the chimney 40 to maximize the amount of heat transferred to the air within the heat exchanger 60. In another embodiment, one or more additional inner partitions inside of the heat exchanger 60 are also contemplated to optimize the airflow path through the heat exchanger 60. Furthermore, in one embodiment, additional conductive material may be placed in the heat exchanger 60 to increase the surface area to optimize the transfer of heat from the air within the chimney 40 to the air within the heat exchanger 60. For example, in one embodiment, conductive material, such as, but not limited to steel wool, copper wire, and/or metal shavings may be packed into the heat exchanger 60. One of ordinary skill in the art will appreciate that the efficiency of the heat exchanger 60 may be a function of the air velocity, the overall length of the heat exchanger, and the hot surface area inside of the heat exchanger passageway itself. Further variations may be made to achieve a target temperature of the heated air. For example, in one embodiment, additional length can be added by adding additional inner partitions 68, which may, for example, create multiple levels inside of the heat exchanger 60 for the air to circulate through multiple revolutions about the chimney 40 before exiting the heat exchanger 60.

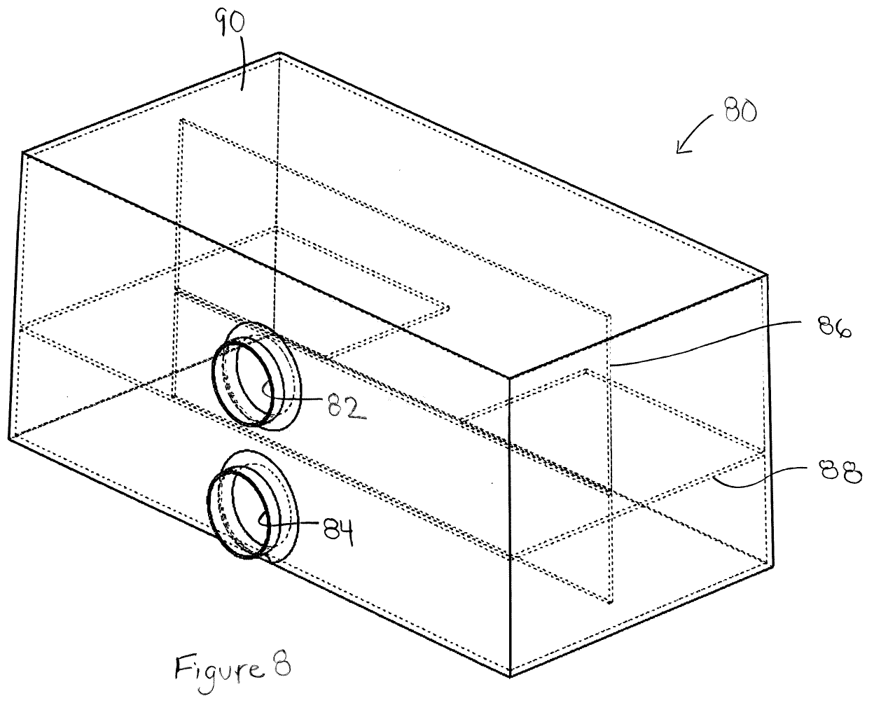

FIG. 8 is a perspective view of one embodiment of a structure 80 having a surface 90 configured to provide heat to a user. As shown, the structure 80 has at least one air inlet 82 and at least one air outlet 84. As shown, the air inlet 82 may be configured to be coupled to conduit 30 to couple the air outlet 64 of the heat exchanger 60 to the air inlet 82 of the structure 80. Thus, the heated air from the heat exchanger 60 is configured to flow through the structure 80 to heat a user.

It should be recognized that at a high level, the structure 80 may simply have an internal air flow passage which is configured to heat at least one surface 90 of the structure 80. The specific configuration of the structure 80 may vary in different embodiments of the present disclosure. As shown, in one embodiment, the structure 80 may have a substantially rectangular cross-section and have a cuboid shape. As shown, in this configuration, the structure may be in the form of a bench sized so that one or more users may sit on the horizontal top surface 90. It should be recognized that in another embodiment, the structure may include at least two surfaces configured to provide heat to a user, for example, a second surface (92 see FIG. 11) may include a seat back which may be oriented substantially perpendicular to the horizontal top surface 90. In another embodiment, the structure 80 may be in the form of an animal bed, such as a dog bed (FIG. 11), and in yet another embodiment, the structure may be in the form of a yoga platform (FIG. 12). One of ordinary skill in the art will recognize that the present disclosure may be utilized with a structure 80 having a variety of shapes and configurations, as the disclosure is not so limited. In one embodiment, the structure 80 is clad with an insulating material such as wood for comfort, aesthetic appeal, and also for safety reasons as to keep the structure 80 from getting too hot. Additional materials may be used to make the structure for either comfort and/or appeal.

As illustrated in FIG. 8, inside of the structure 80, the air is configured to flow from the air inlet 82 to the air outlet 84 to flow heated air from the heat exchanger 60 through the structure 80 to warm at least the surface 90. As shown, the air inlet 84 may be configured to be coupled to conduit 32 to couple the air outlet 84 of the structure 80 to the air inlet 22 of the air receptacle 20. Thus, the heated air from the structure 80 is configured to flow back into the air receptacle 20.

As shown in FIG. 8, in one embodiment, the structure 80 includes at least one inner partition 86, 88 configured to guide airflow inside of the structure 80. In one particular embodiment, a first inner partition 86 is arranged in a substantially vertical orientation so that air must flow around to either end of the structure 80 and then around the first inner partition 86. In one embodiment, a second inner partition 88 is arranged in a substantially horizontal orientation which creates at least a lower level and an upper level. In the embodiment illustrated in FIG. 8, the air flows from an upper level then down to a lower level before exiting the structure through the air outlet 84. As shown, the partition 88 may include a center opening to permit the air to pass between the upper level and the lower level.

In one embodiment, the device includes three primary components: the air receptacle 20, the heat exchanger 60, and the structure 90. A fire may be built in the device 100, and for example, in one embodiment, a fire may be built on top of a grate 50 which is suspended over the air receptacle 20. The heat exchanger 60 may be positioned above the grate 50 and the above-described air inlets and air outlets are connected to create a one-way closed system of air flow that connects the air inlets 62 in the heat exchanger 60 to the air in the air receptacle 20 via the structure 80. As the fire burns, low pressure may develop in the air receptacle 20 which may create a vacuum pull on the air entering the system at the heat exchanger 60. The hot air is drawn into the structure 80 where the heat may radiate through the internal air flow passages inside of the structure 80.

In one embodiment, the device 100 is configured to work without electricity, motors and/or fans. In other words, the device 100 may be configured so that the low-pressure vacuum created inside of the device 100 is enough to create adequate air flow through the device. It is also contemplated that in another embodiment, electricity, motor and/or a fan may be provided to enhance the low-pressure vacuum.

In one embodiment, the device 100 is modular to facilitate using the combination of the air receptacle 20, chimney 40, and heat exchanger 60, to various sized seating area boxes (i.e., structures 80) of any different size and shape. In one embodiment, the device 100 is devoid of an electric motor, but the combination of the air receptacle 20, chimney 40, and heat exchanger 60, can in essence act as a “motor” by creating a vacuum inside of the device to move the air throughout the device 100. It is contemplated that in one embodiment, there may be multiple combinations of the air receptacle 20, chimney 40, and heat exchanger 60 which may all work together to provide heated air to a larger structure 80, and or there may be a plurality of air receptacles 20, chimneys 40, and heat exchangers 60 which may all work together to provide heated air to a plurality of structures 80 configured to provide heat to a user.

In one embodiment, the device 100 may use a wood-based fuel as the combustible material, which when burned on the grate 50 positioned inside of the heat exchanger 60 may create an area of convective low pressure in the air receptacle 20 which may pull on the air contained in the device 100 and may draw ambient air across the walls of the heat exchanger 60, into the structure 80, and then back into the air receptacle 20 to pass through the grate 50 to continue to feed the fire. The vacuum powered air flow may be harnessed using symmetrical low pressure from the center, to the sides, to the center, on the top and the bottom of the structure 80 so as to keep the air flow even and orderly, and to disperse the heat across the entire area of the structure 80. The configuration of the air flow inside of the structure 80 may be the same on the top half as the bottom half and may provide the space to reverse the direction of airflow, so that the air can pass smoothly into and out of the structure 80 from the same plane.

In one embodiment, the heat exchanger 60 may have a design which may allow air into the heat exchanger 60 at a high velocity, low volume rate with multiple small holes (i.e., air inlets 62) positioned on an upper portion of the heat exchanger 60 allowing ambient air to enter the device 100. It is contemplated that the outer walls of the heat exchanger 60 may have any size and shape. In one particular embodiment, the heat exchanger 60 may also be defined as a heating collar, and in one embodiment, the heat exchanger 60 is substantially ring-shaped.

As the air enters the seating structure 80 from the heat exchanger 60, it may be drawn in one of two directions, either toward the low-pressure area to the far right or the far left. The flow of air may be directed by the vertical inner partition 86 (i.e., dividing wall) within the structure 80 which may be long enough to seal the passage except for at each end of the structure 80. The diameter of the airflow passages within the structure 80 may be greater in comparison to other portions of the device 100 to decrease the velocity of the air, providing more time for the seating structure 80 to derive heat from the air which passes through it. As the air circulates through from the seating structure 80 and enters the air receptacle 20, the air may continue to pass through the grate 50 and supply the fire with oxygen. The force of the fire burning on the grate 50 above may apply low pressure to the air in the air receptacle 20 which may in turn apply low pressure to the air contained within the device 100.

As shown in FIGS. 1-3 and 9, in one embodiment, the device 100 has a stackable configuration where the heat exchanger 60 is stackable on top of the air receptacle 20. Furthermore, one embodiment, the device 100 has a nestable configuration where the grate 50 is nestable within the air receptacle 20, and may for example, rest on a rim formed around the air outlet 24 of the air receptacle, and the chimney 40 may be nestable within the heat exchanger 60. It should be recognized that the stackable and nestable configuration may provide an airtight fit between components to minimize air loss through the device 100.

As shown in FIGS. 1-3, in one embodiment, the height of the chimney 40 is greater than the height of the heat exchanger 60 such that the chimney 40 extends above the heat exchanger 60. In another embodiment, the height of the chimney 40 may be substantially the same as height of the heat exchanger 60 and/or the chimney 40 may not extend above the heat exchanger 60 as the present disclosure is not so limited. Furthermore, it is also contemplated that one or more of the above-described components may be integrally formed together. For example, the inside wall 66 of the heat exchanger 60 may also form the chimney 40.

It should be appreciated that a variety of materials may be used to manufacture the above-described device 100. For example, in one embodiment various metals may be used.

FIG. 10 is a top view of another embodiment of a device 200 for generating heat to a user. This device includes many of the above-described components, but in this particular configuration, the structure 80 is configured as a substantially C-shaped bench which partially extends around the chimney 40.

FIG. 11 is a side view of another embodiment of a device 300 for generating heat to a user. Similarly, this device 300 includes many of the above-described components, but in this particular configuration, the structure 80 is configured as a couch including at least two surfaces 90, 92 configured to provide heat to a user, as well as an animal bed, such as a dog bed.

FIG. 12 is a side view of yet another embodiment of a device 400 for generating heat to a user. In this particular device 400, the structure 80 is configured as a yoga platform.

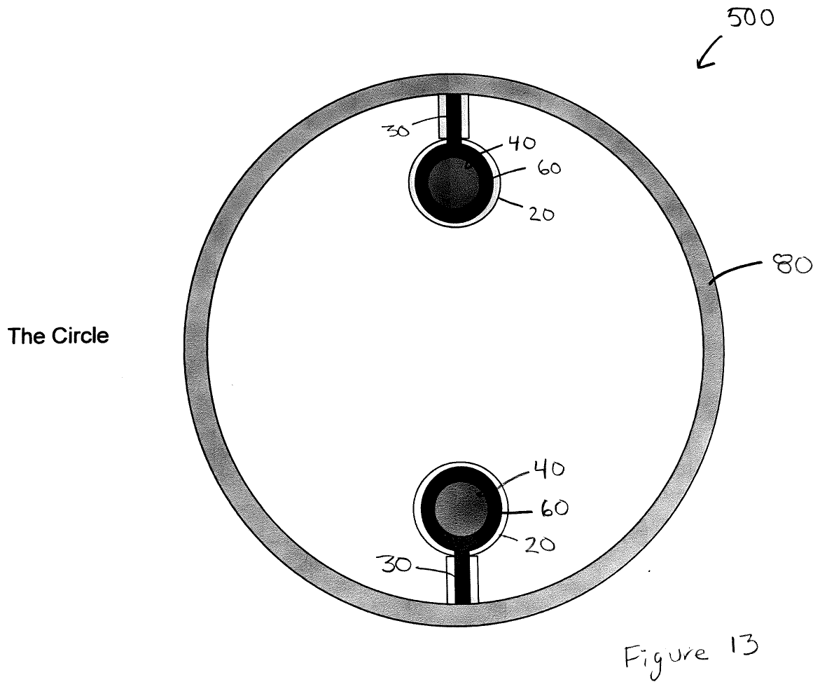

Finally, FIG. 13 is top view of another embodiment of a device 500 for generating heat to a user. In this particular device 500, the structure is configured as a circular seat and/or bench which in this particular embodiment includes two chimneys 40 and two heat exchangers 60 to generate heated air to flow through the circular structure 80.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

What is claimed is:

1. A device for generating heat to a user, the device comprising:
an air receptacle having at least one air inlet and one air outlet;
a chimney having a first end coupled to the at least one outlet of the air receptacle, and a second open end;
a heat exchanger positioned about a periphery of the chimney, the heat exchanger having at least one air inlet and at least one air outlet;
a structure having at least one surface configured to provide heat to a user, wherein the structure has at least one air inlet coupled to the at least one air outlet of the heat exchanger, and wherein the structure has at least one air outlet coupled to the at least one air inlet of the air receptacle; and
wherein the device is configured such that when a combustible material is placed in the device, the device heats air within the air receptacle and the heated air travels through the chimney, heating the air within the heat exchanger, circulating the air from the heat exchanger into the structure, and back into the air receptacle.

2. The device of claim 1, further comprising a grate positioned adjacent the air receptacle, wherein the grate is configured to hold a combustible material.

3. The device of claim 2, in combination with a combustible material positioned on the grate, wherein the combustible material is configured to heat air within the device.

4. The device of claim 1, wherein the structure having at least one surface configured to provide heat to a user includes at least one inner partition configured to guide airflow inside of the structure.

5. The device of claim 1, wherein the structure having at least one surface configured to provide heat to a user is in the form of at least one of a chair, a bench, a yoga platform, and an animal bed.

6. The device of claim 1, wherein the heat exchanger further includes at least one inner partition configured to guide airflow inside of the heat exchanger.

7. The device of claim 1, wherein the heat exchanger is substantially ring shaped.

8. The device of claim 1, wherein the heat exchanger is positioned about the entire periphery of the chimney.

9. The device of claim 1, wherein the device is configured to create a vacuum inside of the device which draws heated air from the heat exchanger into the structure to heat a user, and back into the air receptacle.

10. The device of claim 9, wherein the device is devoid of an electric motor.

11. A device for generating heat to a user, the device comprising:
an air receptacle having at least one air inlet and one air outlet;
a chimney having a first end coupled to the at least one outlet of the air receptacle, and a second open end;
a grate positioned adjacent the air receptacle, wherein the grate is configured to hold a combustible material;
a heat exchanger positioned about a periphery of the chimney, the heat exchanger having at least one air inlet and at least one air outlet; and
wherein the device is configured such that when a combustible material is placed on the grate, the device heats air within the air receptacle and the heated air travels through the chimney, heating air within the heat exchanger.

12. The device of claim 11, wherein the device has a stackable configuration, wherein the heat exchanger is stackable on top of the air receptacle.

13. The device of claim 12, wherein the device has a nestable configuration, wherein the grate is nestable within the air receptacle, and the chimney is nestable within the heat exchanger.

14. The device of claim 11, further comprising a structure having at least one surface configured to provide heat to a user, wherein the structure has at least one air inlet coupled to the at least one air outlet of the heat exchanger, and wherein the structure has at least one air outlet coupled to the at least one air inlet of the air receptacle, and wherein the device is configured to circulate the heated air from the heat exchanger into the structure, and back into the air receptacle.

15. The device of claim 14, wherein the structure having at least one surface configured to provide heat to a user is in the form of at least one of a chair, a bench, a yoga platform, and an animal bed.

16. The device of claim 11, in combination with a combustible material positioned on the grate, wherein the combustible material is configured to heat air within the device.
